(19) United States
(12) Patent Application Publication
(10) Pub. No.: US 2012/0185621 A1
(43) Pub. Date: Jul. 19, 2012

(54) Detection and Processing of Preselected Image Blocks in a KVM System

(75) Inventors: George Richard Goodley, II, Pompano Beach, FL (US); Mario Costa, Davie, FL (US)

(73) Assignee: Avocent Huntsville Corporation, Huntsville, AL (US)

(21) Appl. No.: 13/008,249

(22) Filed: Jan. 18, 2011

(51) Int. Cl. G06F 13/12

(52) U.S. Cl. 710/62

(57) ABSTRACT

A method, operable in a keyboard, video, mouse (KVM) system in which multiple target computers connected to a KVM switch are accessible via the KVM switch by a remote computer connected to the KVM switch, each of the target computers having a video output, and in which one or more preselected images are each associated with corresponding actions, the method includes monitoring the video output of at least some of the target computers connected to the KVM switch to search for one of the preselected images in the video output; and when one of the preselected images is detected in a video output of one of the target computers, taking the corresponding actions associated with that image.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

This invention relates to Keyboard, Video and Mouse (KVM) systems, and, more particularly, to message processing and handling in KVM system.

### BRIEF DESCRIPTION OF THE DRAWINGS

The following description, given with respect to the attached drawings, may be better understood with reference to the non-limiting examples of the drawings, wherein:

FIG. 1 shows an overview of a typical KVM system;

FIG. 2 is a flowchart of a setup process;

FIG. 3 shows exemplary data structures in a memory;

FIG. 4 is a flowchart of a use of the system;

FIG. 5 shows a device for handling preselected message in a KVM system; and

FIG. 6 shows a captured video screen.

### THE PRESENTLY PREFERRED EXEMPLARY EMBODIMENTS

### Introduction & Background

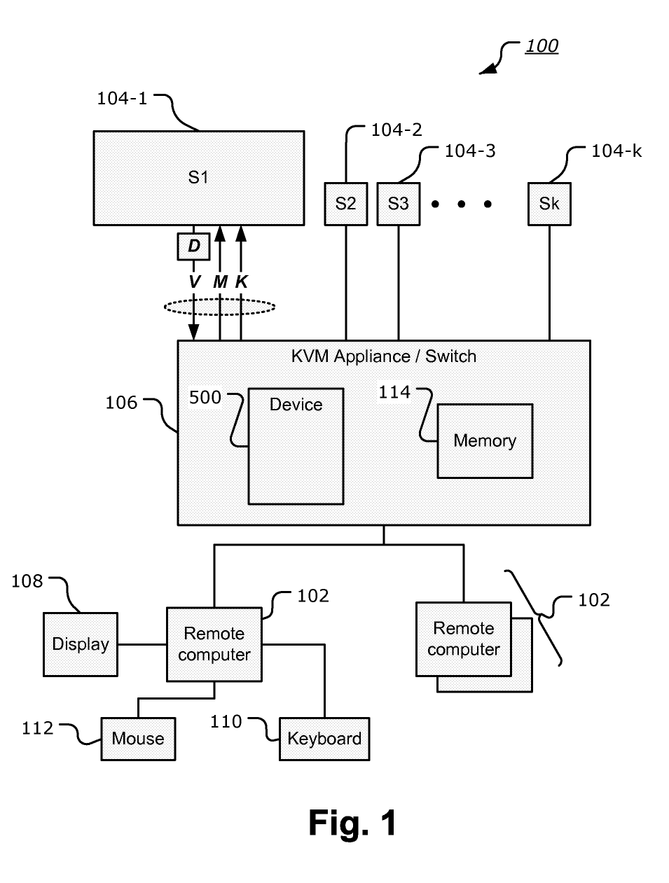

FIG. 1 shows a typical KVM system 100 in which one or more remote computers 102 can access one or target systems 104-1, . . . , 104-k (collectively 104), e.g., via a KVM appliance switch 106. As is well known, each of the various target systems 104 can be selectively monitored and controlled by a remote computer 102 via the KVM switch 106. The target systems 104 may be directly connected to the KVM switch 106 or connected thereto via one or more other devices (not shown). Video output (V) from a target system 104 can be displayed on the display screen 108 of a remote computer 102, and keyboard and mouse inputs from a keyboard 110 and mouse 112 of the remote computer 102 can be provided to a selected target system 104 via the KVM switch 106.

A KVM system is described in U.S. Published Patent Applications Nos. 2008-0040522 (application Ser. No. 11/523,582, filed Sep. 20, 2006, titled “Rack interface pod with intelligent platform control”) and 2008-0052442 (application Ser. No. 11/882,557, filed Aug. 2, 2007, titled “Rack Interface Pod with intelligent platform control”), the entire contents of each of which are fully incorporated herein for all purposes.

In operation of a KVM system, target systems 104 (computers, servers and the like) may generate on-screen messages which may require operator invention or detection. Using the system described herein, rather than have an operator look for and intervene for each on-screen message, some (one or more) potential on-screen messages are preselected and responses to those preselected messages are pre-set. Then, in operation, when one of the preselected on-screen message appears on one of the screens of a target system (or in the video output of a target system), the corresponding responses to those preselected messages are performed. Those of skill in the art will realize and understand, upon reading this description, that some or all of the target systems 104 may not have actual monitors connected directly thereto. Accordingly, the video output of a target system may not actually be displayed at the target system itself, and may only be provided in the video output of the target system to the remote computers 102 via the KVM switch 106.

### Setup Mode

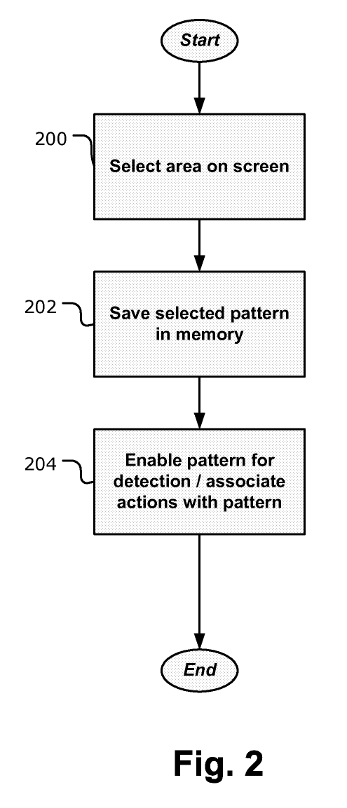

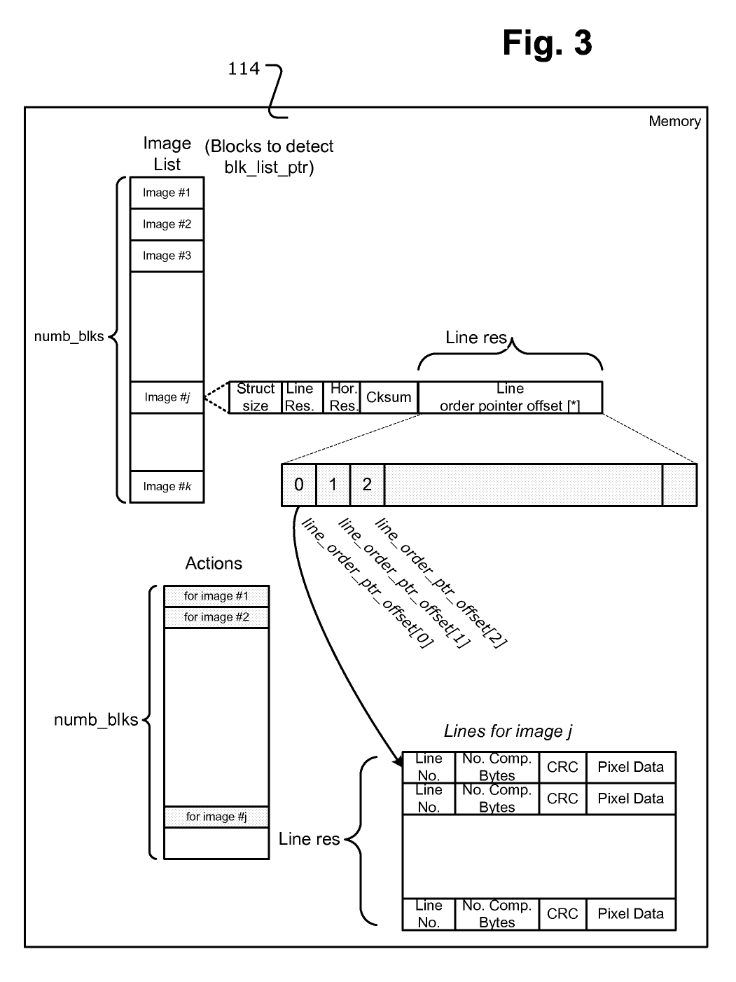

In a setup mode, various on-screen images are associated with corresponding actions. FIG. 2 is a flowchart of an exemplary setup process for the message handling system, and FIG. 3 shows exemplary data structures in a memory 114 of the KVM switch 106.

An operator causes the on-screen image to be displayed (e.g., by forcing an error or an event to occur or by accessing a database of images). The operator selects the area of the screen containing the image (at 200) and the image is stored in memory and enabled for detection (at 202). The operator also associates a predetermined response to the image (at 204). The response may be a series of key strokes, mouse clicks, and the like, and may include logging the occurrence of the image and alerting an operator. The predetermined responses are stored in the memory (e.g., in an Actions table that has an entry for each of the preselected images).

### Image Block Structure

In a presently preferred implementation, each image block to detect is stored in memory in a structure as follows:

```
struct_size
line_res, hor_res
cksum
line_order_ptr_offset[line_res]
  line_numb, comp_bytes
  crc32
  pixel_data[comp_bytes]
```

The struct_size (structure size) is the number of 32-bit locations the structure takes up. The line_res, hor_res (line and horizontal resolution) define the size of the image block in pixels.

The cksum, (check sum) is the sum of each pixel of the first line to be searched for of the image block. This may not be the first line of the block, but the line in the block with the most number of compressed bytes.

The structure line_order_ptr_offset[line_res] is an array of pointer offsets in the structure that points to the lines in the order in which they should be searched. The lines are put in the order of the number of bytes it takes to compress the line from the most compressed bytes to the least compressed bytes. Lines with the most compressed bytes are least likely to detect a match with other lines in the frame when the image being searched for is not actually in the frame.

Each line of the image block has the following structure:

Line_numb (line number) line number in the block of the of the compressed line. The lines will be in sequential order starting with line number zero (0).

Comp_bytes (compressed bytes) is the number of bytes that the line is compressed into.

CRC32 (32 bit CRC (“Cyclic Redundancy Check”) value) when the line is uncompressed and the CRC is calculated, it should match this value.

Pixel_data[comp_bytes] is the compressed pixel data for the line.

Blocks to detect structure: is a structure with a list of pointers to the image blocks to detect.

| | | |
|---|---|---|
| Blks_2det_struct : | | |
| numb_blks | -- | number of blocks to |
| | | search for |
| blk_list_ptr[numb_blks] | -- | array of pointers in |
| | | memory of which blocks |
| | | search for |

Those of skill in the art will realize and understand, upon reading this description, that different and/or other data structures may be used to store the image data for the image blocks to be detected and/or for the corresponding actions to be taken when an image block is detected.

### Use Mode

In use mode, the terminal screen of each computer connected to the KVM switch is monitored, and when a preset image is detected on the screen, the predetermined action associated with that image is taken. In this manner no ongoing and constant operator monitoring is required.

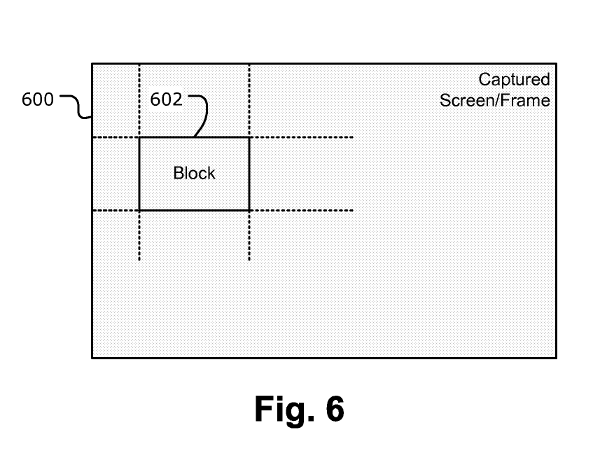

Image block detection is the ability search through a captured video screen (600 in FIG. 6) for a predefined image block 602 with a specified rectangular block size of any horizontal and vertical resolution. While described here with reference to rectangular blocks, those of skill in the art will realize and understand, upon reading this description, that the algorithm could also be adapted to non-rectangular block sizes.

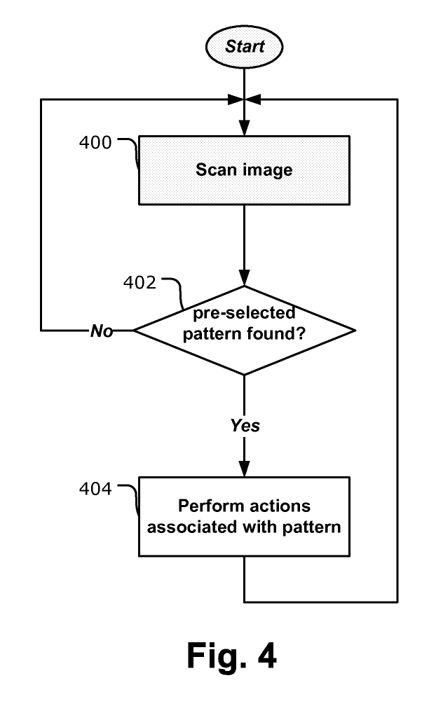

FIG. 4 is a flowchart of aspects of the use of the message handling system. For each target system connected to the KVM switch, the display of the screen is searched (at 400), and if one of the predetermined on-screen images is found (at 402), the predetermined actions associated with that image are performed (at 404). The predetermined actions (response) to that image may include sending an alert to an operator, and/or capturing and storing the image, and/or responding to the image.

The block to detect 602 could be anywhere within a captured screen 600 or even the same size as a whole captured screen. Multiple images to detect are compressed and stored in memory. A list of the image blocks to search for is kept in memory. After each video frame from a target system 104 is captured (as captured screen 600), the system searches through the captured frame/screen for each image in the list of preselected image blocks. If none of the image blocks are found, then another frame will be captured and the process is repeated. If a preselected image block is detected, then the actions associated with that image block are carried out.

### The Image Block Detection Algorithm

The image block detection algorithm operates as follows:

Block search:
1. Capture a video frame.
2. Start the search with the line of the block with the most number of compressed bytes. The order of the lines in the block to search for is determined by the complexity of the line. Search for the most complex lines first to avoid having matching lines but not matching blocks. In a presently preferred embodiment, the complexity of a line is determined by the number of bytes it takes to compress that line. The more bytes it takes to compress a line, the more complex the line is considered to be (for the sake of this algorithm).
3. Calculate the checksum (cksum) for first line of the block to detect and then search the frame buffer for a location in which the checksum matches. This is referred to as a “rolling cksum” or “rolling checksum” because recalculating the checksum (cksum) for the next set of pixels in the captured line is done by subtracting the pixel data to the left and adding the pixel data to the right. This approach avoids having to compare pixel by pixel for an entire block line, looking for a match and having to start all over again when there is a mismatch. The rolling checksum (cksum) formula is given by:

cksum=cksum+pixel(hor_{—}res+x)−pixel(x)
4. If a location is found with a matching checksum (cksum), then each pixel in the line is compared starting with the column with the matching checksum (cksum). If any pixel does not match, it is assumed that there is no match, so abort and continue the rolling checksum (cksum) with next pixel position in the frame buffer. If all of the pixels match in the line, then the next block detect line and the next frame line are loaded and comparing pixels is continued starting at the same column number. If any pixel does not match, then the pixel compare is aborted and the rolling checksum (cksum) is continued with the next pixel position.
5. If all pixels match, then the block was found. Start searching for the next block.
6. If there are no checksum (cksum) matches or block matches found in the in the frame buffer, start looking for the next block to detect.
7. If none of the blocks are detected, go back to step 1 and capture a new video frame.

In a currently preferred implementation, the biggest time savers when searching for a small block in a big frame are:

1. The rolling check sum.

2. The order of the lines to search for.

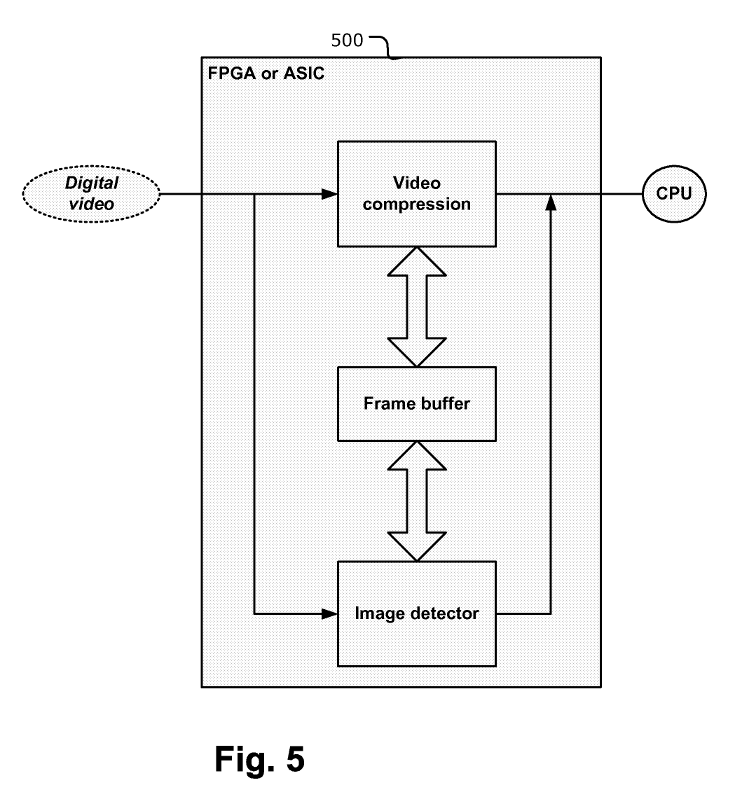

FIG. 5 shows a device 500 for handling preselected message in a KVM system. The device 500 may be, e.g., an FPGA or ASIC and is preferably included in the KVM switch 106. The memory 114 may be part of the device 500 or it may be separate.

The computer(s) and devices on which the program(s) operate may be any general purpose or special purpose computer(s) that can host the web-sites. Aspects of the present invention can be implemented as part of the processor or as a program residing in memory (and external storage) and running on processor, or as a combination of program and specialized hardware. When in memory and/or external storage, the program can be in a RAM, a ROM, an internal or external disk, a CD ROM, an ASIC or the like. In general, when implemented as a program or in part as a program, the program can be encoded on any computer-readable medium or combination of computer-readable media, including but not limited to a RAM, a ROM, a disk, an ASIC, a PROM and the like. The target computer(s) 104 and remote computers 102 can run any operating system(s), and need not be homogeneous.

Although aspects of this invention have been described with reference to a particular system, the present invention operates on any computer system and can be implemented in software, hardware or any combination thereof. When implemented fully or partially in software, the invention can reside, permanently or temporarily, on any memory or storage medium, including but not limited to a RAM, a ROM, a disk, an ASIC, a PROM and the like.

While certain configurations of structures have been illustrated for the purposes of presenting the basic structures of the present invention, one of ordinary skill in the art will appreciate that other variations are possible which would still fall within the scope of the appended claims. While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A method, operable in a keyboard, video, mouse (KVM) system in which multiple target computers connected to a KVM switch are accessible via the KVM switch by a remote computer connected to the KVM switch, each of the target computers having a video output, and in which one or more preselected images are each associated with corresponding actions, the method comprising:
monitoring the video output of at least some of the target computers connected to the KVM switch to search for one of the preselected images in the video output; and
when one of the preselected images is detected in a video output of one of the target computers, taking the corresponding actions associated with that image.

2. The method of claim 1 wherein the actions associated with an image are selected from the actions comprising:
(a) sending an alert to an operator,
(b) capturing and storing the image, and
(c) responding to the image.

3. The method of claim 2 wherein responding to the image comprises: sending instructions to the one of the target computers.

4. A device, operable in a keyboard, video, mouse (KVM) system in which multiple target computers connected to a KVM switch are accessible via the KVM switch by a remote computer connected to the KVM switch, each of the target computers having a video output, and in which one or more preselected images are each associated with corresponding actions, the device configured to:
monitor the video output of at least some of the target computers connected to the KVM switch to search for one of the preselected images in the video output; and
when one of the preselected images is detected in a video output of one of the target computers, to take the corresponding actions associated with that image.

5. The device of claim 4 wherein the actions associated with an image are selected from the actions comprising:
(a) sending an alert to an operator,
(b) capturing and storing the image, and
(c) responding to the image.

6. The device as in claim 4 wherein the device is included in the KVM switch.
